(19) United States
(12) Patent Application Publication
(10) Pub. No.: US 2026/0176905 A1
(43) Pub. Date: Jun. 25, 2026

(54) LOW PROFILE HIGH THROW CAM SYSTEM FOR CLOSING AND SEALING A GARAGE DOOR

(71) Applicant: Dennis Palmer, Riverton, UT (US)

(72) Inventor: Dennis Palmer, Riverton, UT (US)

(21) Appl. No.: 19/420,701

(22) Filed: Dec. 15, 2025

Related U.S. Application Data
(60) Provisional application No. 63/736,514, filed on Dec. 19, 2024.

(51) Int. Cl. E05D 15/24

(52) U.S. Cl. CPC E05D 15/248; E05Y 2201/626; E05Y 2201/684; E05Y 2900/106

(57) ABSTRACT

A garage door motion assembly moves a garage door horizontally towards the wall surrounding the garage door opening as the garage door travels through its last few inches of closing travel. The garage door is moved horizontally into the garage door seal, creating a better seal between the door and the door seal. The horizontal movement of the garage door towards the seal may be precisely adjusted to create the desired closure motion and sealing performance of the garage door. Damage to the garage door and door seal while closing is avoided.

### PRIORITY

The present application claims the benefit of U.S. Provisional Application Ser. No. 63/736,514, filed Dec. 19, 2024, which is herein incorporated by reference in its entirety.

### THE FIELD OF THE INVENTION

The present invention relates to garage doors. In particular, examples of the present invention relate to a motion system for garage doors which moves the garage door horizontally against the door seal as the door closes to improve the closure motion and sealing of the garage door.

### INTRODUCTION

Residential garage doors typically include four or more horizontal panels that are hinged together and move along a track to open or close the door. A seal is placed between the garage wall and the door. Existing garage doors do not seal well and dust and debris are frequently blown past the seal by the wind. Additionally, the garage door seals wear out and tear as the door slides along the seal while opening and closing. The present disclosure provides an improved garage motion system that improves the garage door closing motion and also improves the performance of the garage door seal.

### BRIEF DESCRIPTION OF THE DRAWINGS

Non-limiting and non-exhaustive examples of the present invention are described with reference to the following figures, wherein like reference numerals refer to like parts throughout the various views unless otherwise specified.

FIG. 1 is a drawing of a garage door motion system for closing and sealing a garage door.

FIG. 2 is a drawing of the garage door motion system of FIG. 1.

FIG. 3A is another drawing of the garage door motion system of FIG. 1.

FIG. 3B is another drawing of the garage door motion system of FIG. 1.

FIG. 4 is another drawing of the garage door motion system of FIG. 1.

FIG. 5 is a drawing of an alternate configuration of the garage door motion system of FIG. 1.

FIG. 6 is a detailed top view drawing of the garage door motion system of FIG. 1.

FIG. 7 is a drawing of the garage door motion system of FIG. 1.

FIG. 8 is a drawing of a garage door motion system linking assembly.

Corresponding reference characters indicate corresponding components throughout the several views of the drawings. Unless otherwise noted, the drawings have been drawn to scale. Skilled artisans will appreciate that elements in the figures are illustrated for simplicity and clarity. For example, the dimensions of some of the elements in the figures may be exaggerated relative to other elements to help improve understanding of various examples of the present invention. Also, common but well-understood elements that are useful or necessary in a commercially feasible embodiment are often not depicted in order to facilitate a less obstructed view of these various embodiments of the present invention.

It will be appreciated that the drawings are illustrative and not limiting of the scope of the invention which is defined by the appended claims. The examples shown each accomplish various different advantages. It is appreciated that it is not possible to clearly show each element or advantage in a single figure, and as such, multiple figures are presented to separately illustrate the various details of the examples in greater clarity. Similarly, not every example need accomplish all advantages of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

In the above disclosure, reference has been made to the accompanying drawings, which form a part hereof, and in which are shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be used in connection with other embodiments whether or not explicitly described. The particular features, structures or characteristics may be combined in any suitable combination and/or sub-combinations in one or more embodiments or examples. It is appreciated that the figures provided herewith are for explanation purposes to persons ordinarily skilled in the art.

As used herein, “adjacent” refers to near or close sufficient to achieve a desired effect. Although direct contact is common, adjacent can broadly allow for spaced apart features. As used herein, the singular forms “a,” and, “the” include plural referents unless the context clearly dictates otherwise.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be such as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a number or numerical range endpoint by providing that a given value may be one or two significant digits above or one or two significant digits below the number or endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Dimensions, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range.

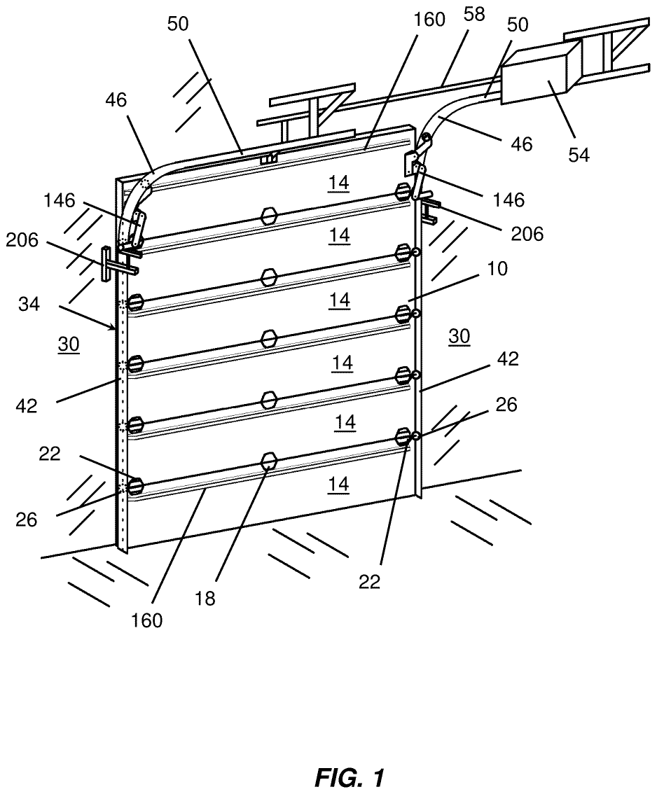

Turning now to FIG. 1, a garage door motion system is shown. The garage door motion system includes a high throw cam that moves the garage door horizontally away from the garage door track to move the garage door towards the wall and against a door seal as the garage door closes to create a better seal around the closed garage door. The garage door motion system allows the door to move freely along the garage door track and moves the door securely against the garage door seal when the door is closed. Some parts of the garage door such as the door torsion springs, sensors, electrical components, etc. are not shown for clarity. The garage door motion system includes a garage door 10. The example garage door 10 includes 6 garage door panels 14 that are connected to each other with hinges. The door panels are connected with center hinges 18 and end hinges 22 at the ends of the panels. The end hinges 22 include supports that hold garage door roller wheels 26, typically by receiving an elongated axle of the roller wheel 26 in a mounting tube.

The garage door rollers 26 ride in garage door tracks and facilitate opening and closing the garage door 10. The garage door tracks typically include a vertical garage door track section 42 that extends vertically along the wall 30 adjacent a garage door opening 34 (covered by the closed garage door 10). The garage door tracks typically also include a curved intermediate garage door track section 46 that attaches to the vertical lower garage door track section 42 and extends upwardly therefrom and curves away from the wall 30 towards a more horizontal direction. The garage door track also typically includes an upper garage door track section 50 that extends horizontally from the curved garage door track section 46. The garage door 10 moves upwardly with the roller wheels 26 moving along the track section 42, 46, 50 until the garage door 10 has moved into an open position. The upper garage door track section 50 supports the garage door 10 when the door 10 is in an open position and the lower garage door track section 42 holds the garage door 10 vertically adjacent the wall 30 when the garage door 10 is in a closed position.

The garage door 10 is opened and closed by a garage door operator 54 and its associated motion control hardware and electronics. The example garage door operator 54 includes an operator motor that is connected to the garage door via a carriage and carriage rail 58.

Many garage doors 10 are installed in garages with a lower amount of vertical clearance above the garage door opening. Home builders may choose to leave less space between the top of the garage door 10 and the garage ceiling because this allows a taller garage door to be used and provides improved garage access. Garage doors 10 with lower overhead clearance are typically installed with a more complex double track arrangement where the top wheel is carried separately on a horizontal upper garage door track disposed above the upper garage door track section 50. Low overhead clearance garage door installations result in more complex installations as well as compromised garage door motion and poorer sealing performance between the garage door 10 and the wall 30.

A high throw cam assembly 146 is attached to the top panel 14 of the garage door 10. The high throw cam assembly is used to move the top panel 14 of the garage door 10 laterally towards the wall 30 as the garage door 10 moves into a closed position. The high throw cam assembly 146 allows a garage door 10 to be installed in a building with low overhead clearance with a single garage door track and also improves the closing and sealing of the garage door 10. The high throw cam assembly 146 moves the door 10 laterally away from the garage door track section 46 and towards the wall 30 when the garage door 10 moves through the last few inches of its travel while closing, mowing the door 10 horizontally against a door seal as the garage door 10 is closed.

As is shown and appreciated from the drawing, the garage door motion system typically includes a high throw cam assembly 146 on both sides of the garage door 10. The example garage door motion system includes left and right high throw cam assemblies 146 with the left side high throw cam assembly 146 and the right side high throw cam assembly 146 having the same components and being symmetrically arranged/mirror images left to right with respect to each other. For clarity, many drawings in the application will show a more detailed view of only one side of the garage door motion system and it is understood that the other side of the garage door motion system typically has the same components symmetrically arranged using left handed components on the left side of the garage door 10 and right handed components on the right side of the garage door 10. The motion of some garage doors 10 may be adequately controlled with a single high throw cam assembly 146 on a single side of the garage door 10.

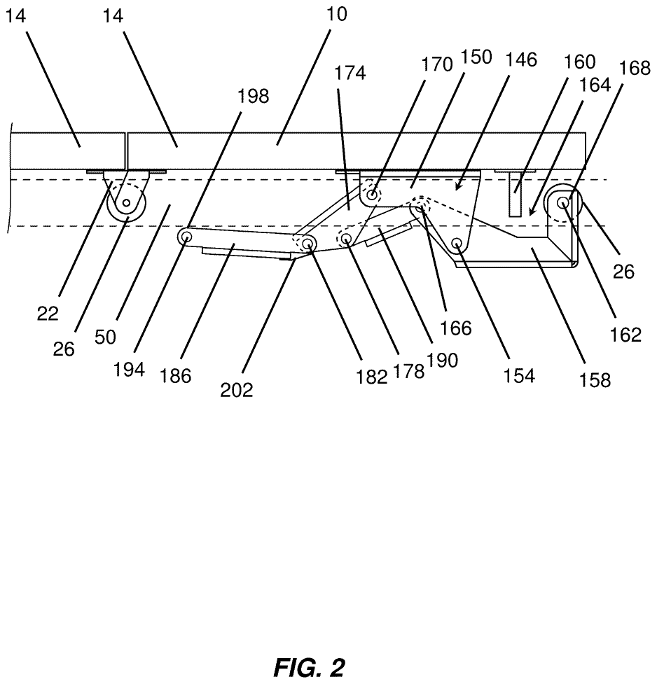

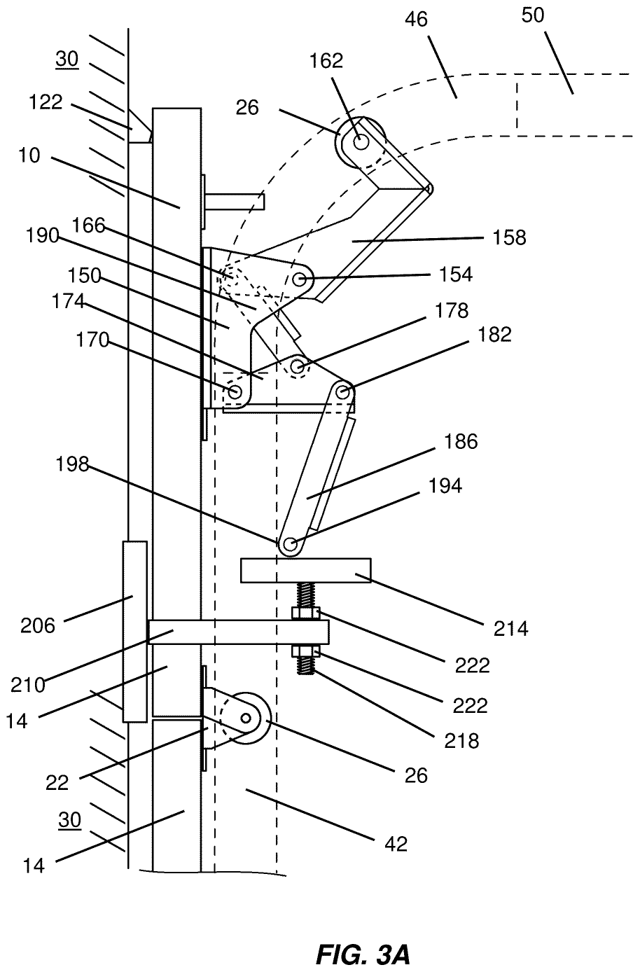

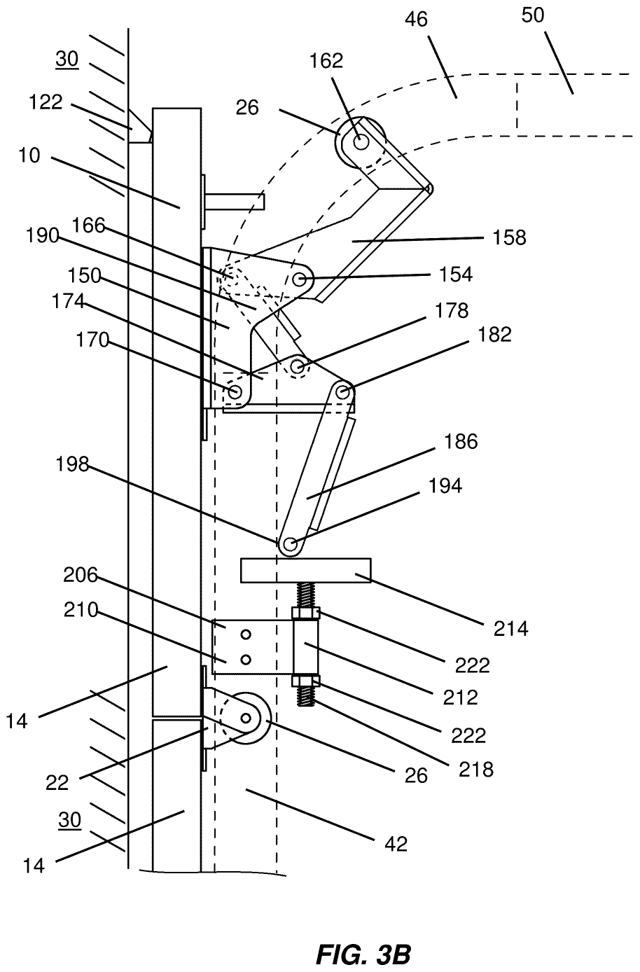

FIGS. 2, 3A and 3B show more detailed side views of the high throw cam assembly 146. FIG. 2 shows a drawing with the garage door 10 open and with the garage door 10 supported by a horizontal upper garage door track section 50. FIGS. 3A and 3B show drawings with the garage door 10 closed. The high throw cam assembly 146 on the right side of the garage door 10 is shown. The high throw cam assembly 146 includes a base bracket 150 that is attached to the garage door 10. The bracket 150 is attached near the side of the upper garage door panel 14 at the side of the garage door 10. The base bracket 150 is generally aligned with the end hinges 22, and is attached near the vertical center of the panel 14 relative to the top and bottom edges of the panel 14. The bracket 150 is U shaped in cross section with a mounting plate and two opposing sides that support the attached axles and arms and a central channel extending along the bracket between the two opposing sides of the bracket. The bracket 150 includes a first pivot point 154. A door closing arm 158 is pivotably attached to the bracket 150 at the pivot point 154 by an axle that passes through the bracket 150 and the door closing arm 158 at the pivot point 154. The distal end of the door closing arm 158 holds a garage door roller wheel 26 at a distal axle location 162 and the roller wheel 26 is carried by the garage door track 50 shown in dashed lines. FIG. 2 shows an upper horizontal section of garage door track 50 is shown with the garage door 10 open and held above the garage door track 50. Garage doors 10 often have stiffening struts 160 that are attached to the inside side of the garage door panels 14 and extend across the width of the door panels 14 to prevent bending of the panel across the width due to the weight of the garage door 10. The distal section of the door closing arm 158 includes a recess indicated at 164 that allows the door closing arm 158 to extend around the door stiffening strut 160. The door stiffening strut 160 is positioned between the bracket 150 and the roller wheel 26 at the end of the closing arm 158 when the door 10 is in an open position as shown in FIG. 2.

The proximal, bracket end of the door closing arm 158 includes a second pivot location 166 which is positioned at the bracket 150 generally on an opposite side of the pivot location 154 compared to the roller wheel 26. About a 135 degree angle is formed between the wheel axle 162, the first pivot point 154, and the second pivot point 166. The door closing arm 158 is generally between about 6 inches and about 8 inches between the pivot 154 and the axle 162, and is about 2 inches long between the pivot 154 and the pivot 166. The distance between the second pivot location 166 and the first pivot location 154 is between about one third and about one fifth of the distance between the first pivot location 154 and the roller wheel axle location 162, and is usually about one fourth of the distance between the first pivot location 154 and the roller wheel axle location 162.

The bracket 150 includes a second pivot location 170 which is spaced apart from the bracket first pivot location 154 by about 4 inches. A second class intermediate lever 174 is pivotably attached to the bracket 150 at pivot location 170 by an axle that passes through the bracket 150 and intermediate lever 174. The intermediate lever 174 includes a second pivot location 178 and a third pivot location 182. An input linkage 186 is attached to the third pivot location 182 by an axle that passes through the input linkage 186 and the intermediate lever 174. A first end of an intermediate linkage 190 is attached to the intermediate lever 174 at a second pivot location 178 by an axle that passes through the intermediate lever 174 and the intermediate linkage 190. The distance between intermediate lever first pivot location 170 and the second pivot location 178 is about two thirds the distance between the first pivot location 170 and the third pivot location 182 so that the intermediate lever 170 reduces the motion between the input linkage 186 and the intermediate linkage 190. The opposing end of the intermediate linkage 190 is attached to the second pivot location 166 of the door closing arm 158 by an axle that passes through the door closing arm 158 and the intermediate linkage 190. The intermediate linkage 190 is about 4 inches long between pivot locations 166 and 178. The input linkage 186 is about 5 inches long between the pivot location 182 and the input axle 194. The opposing end of the input linkage 186 has a laterally extending axle 194 that forms an input arm to actuate the high throw cam assembly 146 as the garage door closes. In the drawing, the input arm extends in a direction in to the page. The example input arm 194 carries a sleeve roller 198 that rides on the bottom/inside edge of the garage door track 42, 46, 50 (the edge of the door track that is opposite the garage door 10 or garage door opening 34). The sleeve roller 198 reduces friction and wear as the input arm 194 moves along the garage door track 42, 46, 50. A spring 202 biases the roller 198 against the garage door track 50 to ensure that the roller does not separate from the garage door track 50 and fail to operate the high throw cam assembly 146. The spring 202 particularly holds the roller 198 against the garage door track 50 against gravity while the garage door 10 is open and disposed in the position shown in FIG. 2.

As the garage door 10 moves to a closed position, the roller wheels 26 move along the garage door track 50, 46, 42 towards the wall 30 and downwardly towards the garage floor. The input axle 194/sleeve roller 198 moves along the inside edge of the garage door track 42, 46, 50 as the garage door 10 closes. When the garage door 10 is near the closed position (typically between about 3 and about 6 inches away from a closed position), the roller 198 contacts a stationary stop bracket 206. The stop bracket 206 actuates the high throw cam assembly 146 as the door 10 continues closing and moves the top of the garage door 10 away from the track 42 and towards the wall 30 to move the door 10 against a door seal. The stop bracket 206 may be mounted to the garage wall 30 as is shown in FIG. 3A. Alternatively, the stop bracket 206 may be mounted to the garage door track, such as along garage door track section 42 or track section 46 as is shown in FIG. 3B.

The example stop bracket 206 shown in FIG. 3A is mounted to the wall 30. The stop bracket 206 includes a mounting base 210 that is attached to the wall 30. The mounting base 210 includes an arm that extends away from the wall 30 to a position adjacent the garage door track. The stop bracket also includes a stop pad 214 that contacts the roller 198 to stop the downward motion of the roller 198. The stop pad 214 includes a threaded rod 218 that extends downwardly from the stop pad 214. The end of the mounting base arm includes a hole that receives the threaded rod 218 to attach the stop pad 214 to the mounting base. Threaded nuts 222 are used with the threaded rod 218 to attach the stop pad 214 to the mounting base 210 at a desired location. The position of the stop pad 214 may be adjusted relative to the stop bracket base 210 by adjusting the nuts 222 and threaded rod 218 to thereby adjust the movement of the high throw cam mechanism 146 in moving the top of the garage door 10 towards the wall 30.

The stop bracket 206 stops the downward movement of the roller 198 and input linkage 186 and causes the input linkage 186 to pivot the intermediate lever 174 upwards. Upward pivoting of the intermediate lever 174 moves the intermediate linkage 190 upwardly and pivots the door closing arm 158 away from the garage door panel 14. Thus, the input linkage 186 actuates the high throw cam assembly 146 as the base bracket 150 continues to move downwardly with the garage door 10. As the garage door 10 and the base bracket 150 continue to move downwardly, the input linkage 178 pivots the intermediate lever 174 upwardly relative to the garage door 10 which thereby moves the intermediate linkage 190 upwardly relative to the garage door 10. Upward movement of the intermediate linkage pivots the distal end of the door closing arm 158 away from the door panel 14 by pivoting the proximal end of the door closing arm 158 upwardly and towards the door panel 14. This moves the upper door roller wheel 26 away from the top door panel 14 and thereby moves the top door panel away from the garage door track 46. As is shown, many low profile garage door installations require a curved garage door track section 46 that begins below the top of the garage door 10 when the garage door 10 is in a closed position. Low profile garage door installations often require an upper door track section 50 that is about at the same height as the top of the garage door 10 with the door in a closed position. The high throw cam assembly 146 provides a top roller wheel 26 that is movable away from the garage door 10 by a distance of 8 inches or greater if needed and allows the top of the garage door 10 to close against the wall 30 even when the track 46 is not adjacent the wall 30 at the level of the top of the door 10. The high throw cam system 146 keeps the door 10 from moving above the garage door track 50 while closing and reduces the overhead clearance needed for the garage door operator rail and garage door components. The closure distance between the garage door 10 and the wall 30 can be adjusted by adjusting the position of the stop bracket 206 and/or stop pad 214, allowing the garage door 10 to be adjusted so that it closes securely against a door seal 122 positioned between the door 10 and the wall 30 when the garage door is fully closed.

Moving the stop pad 214 upwardly will increase the throw of the high throw cam assembly 146 and increase the distance by which the roller wheel 26 is moved away from the door 10. This increases the movement of the door 10 away from the garage door track and moves the door 10 closer to the wall 30 when the garage door 10 is in the closed position. Similarly, moving the stop pad 214 downwardly will decrease the throw of the high throw cam assembly 146 and will move the garage door 10 away from the wall 30 when the garage door 10 is in the closed position. The vertical position of the garage door 10 is controlled by the garage door opener 54 and is not altered by moving the stop pad 214. Adjustment of the stop pad 214 changes the movement of the input linkage 186, intermediate lever 174, intermediate linkage 190, and door closing arm 158 to adjust the horizontal position of the garage door 10 against the door seal 122.

FIG. 3B shows a drawing that is the same as FIG. 3A except that the stop bracket 206 is mounted to the garage door track section 42 instead of to the wall 30. The stop bracket 206 includes a mounting base 210 that is attached to the garage door track section 42. The mounting base 210 includes a mounting hole that is used to attach the stop pad 214. The example mounting base 210 includes an attached section of steel tubing 212 that is positioned with its central bore disposed vertically. The stop bracket 206 also includes a stop pad 214 that contacts the roller 198 to stop the downward motion of the roller 198. A vertically oriented threaded rod 218 is used to mount the stop pad 214. The mounting base 210 provides a hole that receives the threaded rod 218 to mount the stop pad 214. Threaded nuts 222 are used with the threaded rod 218 to attach the stop pad 214 to the mounting base 210. The position of the stop pad 214 may be adjusted relative to the stop bracket base 210 by adjusting the nuts 222 and threaded rod 218.

As discussed above, the stop bracket 206 stops the downward movement of the roller 198 and causes the input linkage 186 to pivot the intermediate lever 174 upwards and actuate the high throw cam assembly 146 as the base bracket 150 continues to move downwardly with the garage door 10. The closure distance between the garage door 10 and the wall 30 can be adjusted by adjusting the position of the stop bracket 206 and stop pad 214, allowing the garage door 10 to be adjusted so that it closes securely against a door seal 122 positioned between the door 10 and the wall 30.

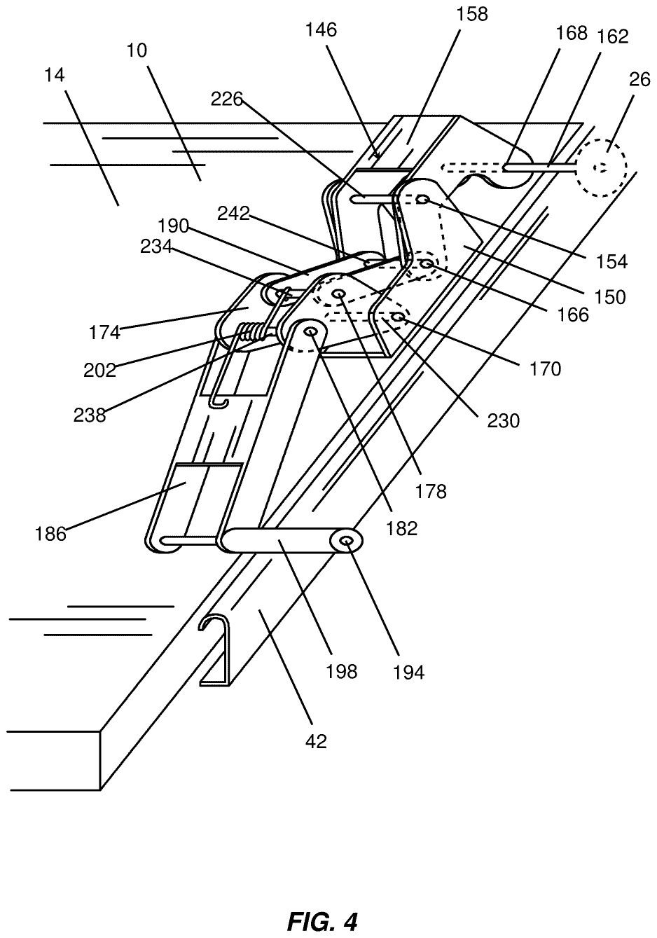

FIG. 4 shows a perspective drawing of the high throw cam assembly 146. The high throw cam assembly 146 is attached to the upper panel 14 of a garage door 10. For clarity, a single garage door panel 14 and only a short section of the garage door track 42 are shown. The base bracket 150 includes a flat central portion that is attached to the garage door 10 and left and right sides that extend away from the central portion and support the other high throw cam assembly components. The bracket 150 is attached near the end of the garage door panel 14 at a location where high throw cam assembly does not interfere with the garage door track 42 and where the roller wheel 26 is able to engage the garage door track 42. The bracket 150 includes holes at the first pivot point 154 and second pivot point 170 that receive first and second pivot axles 226, 230 that provide pivot joints. The pivot axles 226, 230 may be bolts and lock nuts, or may alternatively be shafts attached with a retaining clip or shafts that are pressed or welded into place. The example high throw cam assembly components each have left and right sides connected together by a central body, plate, or shaft. The example structure provides greater strength and rigidity to the assembly.

The door closing arm 158 includes left and right sides that are connected by a central plate. The door closing arm 158 also includes holes that receive the pivot axle 226 to attach the door closing arm 158 to the bracket 150 at the pivot point 154 and holes 166 that receive pivot axle 242 to attach the intermediate lever. The door closing arm includes holes 168 that carry the roller wheel axle 162 and roller wheel 26.

The intermediate lever 174 includes holes at the three pivot locations 170, 178, and 182 that receive pivot axles 230, 234, and 238. The intermediate lever 174 is pivotably attached to the bracket 150 at pivot location 170 by axle 230. The input linkage 186 is attached to the intermediate lever 170 at the third pivot location 182 by axle 238. Intermediate linkage 190 includes holes at its two ends at pivot locations 182 and 166 and is attached to the intermediate lever 170 at the second pivot location 178 by the pivot axle 234 and to the proximal end of the door closing arm 158 at pivot location 166 by axle 242.

The input linkage 186 includes holes at its two ends at pivot location 182 and to receive the input/roller axle 194. The input linkage is attached to the intermediate lever 174 at pivot location 182 by axle 238. The roller axle 194 extends sufficiently far from the input linkage 186 so that the axle 194 and roller 198 extend past the garage door track 42. The roller 198 contacts and rolls along the bottom or inside edge of the garage door track. The roller 198 extends sufficiently far past the garage door track 42 so that it will contact stop bracket 206 while the garage door 10 is closing and so that the roller 198 and input axle 194 will actuate the high throw cam assembly 146. Spring 202 biases the roller 198 against the garage door track 50 to ensure that the roller 198 contacts the stop bracket 206 and operates the high throw cam assembly 146. The spring 202 particularly holds the roller 198 against the garage door track 50 against gravity while the garage door 10 is open. As shown, the spring 202 may be a torsion spring that is mounted to axle 238 and acts on the input linkage 186 and the intermediate lever 174 or axle 234 to bias the input axle 194 towards the garage door track. Alternately, the spring 202 may be a tension spring that is attached to the body of the input linkage 186 or input axle 194 and is attached to the axle 230 to bias the input axle 194 towards the garage door track.

The base bracket 150 is about three inches wide between the left and right sides. This allows the door operating arm 158 and the intermediate lever 174 to be about 2.7 inches wide and the intermediate linkage 190 and input linkage 186 to be about 2.4 inches wide. Each of these components may have left and right side plates that are connected to each other by a center plate or brace or by the attached axles. This provides sufficient strength against bending or twisting under the weight of the garage door 10 and the forces involved with opening and closing the garage door 10. The door operating arm 158, intermediate lever 174, intermediate linkage 190, and input linkage 186 are commonly made from metal such as steel that is about ⅛ inch thick.

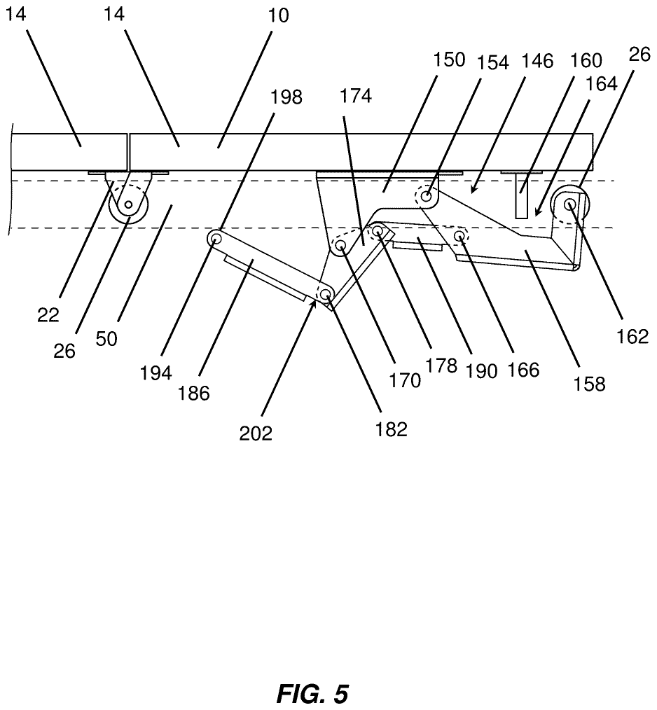

FIG. 5 shows an alternate configuration of the high throw cam assembly 146. In this configuration, the inner end of the door closing arm 158 is attached to the base bracket 150 at the pivot point 154 and the pivot location 166 is disposed between the pivot location 154 and the door roller 26. The intermediate lever 174 is attached to the bracket 150 at pivot location 170 with this pivot located near the middle of the intermediate lever. The input linkage 186 is attached to the intermediate lever 170 at the third pivot location 182 on the end of the intermediate lever 174 that is located away from the garage door 10. Intermediate linkage 190 is attached to the intermediate lever 170 at the second pivot location 178 on the opposite side of the intermediate lever 174 and to the door closing arm 158 at pivot location 166 with this location towards the center of the door closing arm 158.

Similar to that discussed above, the roller 198 contacts and rolls along the bottom or inside edge of the garage door track and extends sufficiently far past the garage door track 42 so that it will contact stop bracket 206 while closing and actuate the high throw cam assembly 146. Spring 202 biases the roller 198 against the garage door track 50. When the roller 198 contacts the stop bracket 206, the stop bracket 206 stops the downward movement of the roller 198 and causes the input linkage 186 to pivot the intermediate lever 174 in a counter-clockwise direction as the base bracket 150 continues to move downwardly with the garage door 10. As the garage door 10 and the base bracket 150 continue to move downwardly, the input linkage 186 pivots the intermediate lever 174 counter clockwise which thereby moves the intermediate linkage 190 downwards under tension. Downward movement of the intermediate linkage 190 pivots the door closing arm 158 away from the door panel 14 and separates the upper door roller wheel 26 from the top door panel 14 and moves the top door panel 14 away from the garage door track 46 and towards the wall 30 so that the top door panel 14 contacts the garage door seal 122.

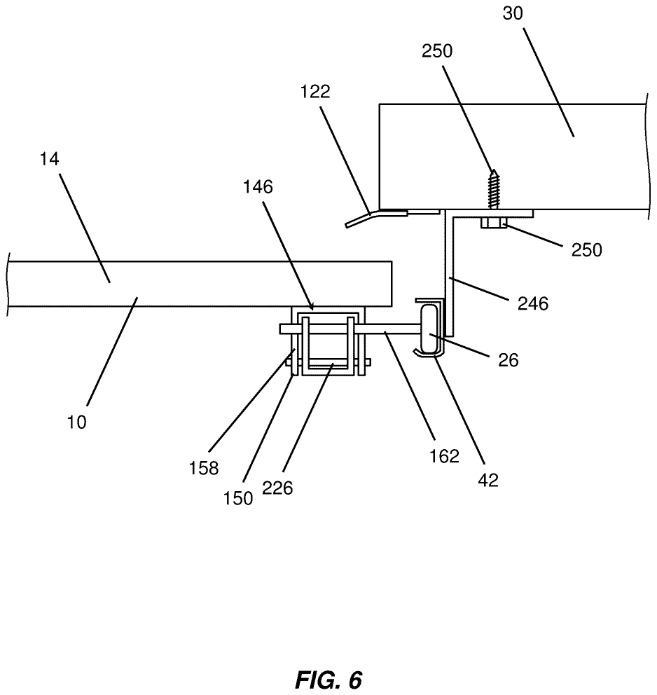

FIG. 6 shows a top view drawing of the garage door 10 and high throw cam system 146 as the garage door 10 approaches a closed position. The garage door track 42 is attached to the wall 30 with a bracket 246 and fasteners 250. This spaces the garage door track 42 a fixed distance from the wall 30. With the garage door 10 still several inches away from a closed position, the upper door panel 14 is still inches away from the wall 30 and garage door seal 122. As the garage door 10 moves the last few inches to the closed position, the door closing arm 158 is pivoted outwardly away from the door panel 14. As the door roller wheel 26 is held in the garage door track 42, moving the door closing arm 158 and roller wheel 26 away from the garage door panel 14 moves the garage door panel horizontally away from the garage door track 42 and towards the wall 30. The garage door panel 14 moves against the door seal 122. Adjusting the position of the stop bracket 206 adjusts the degree of actuation of the high throw cam assembly 146 and adjusts the degree of movement of the garage door panel 14 into the door seal 122, allowing the user to precisely adjust the closing and sealing of the garage door 10.

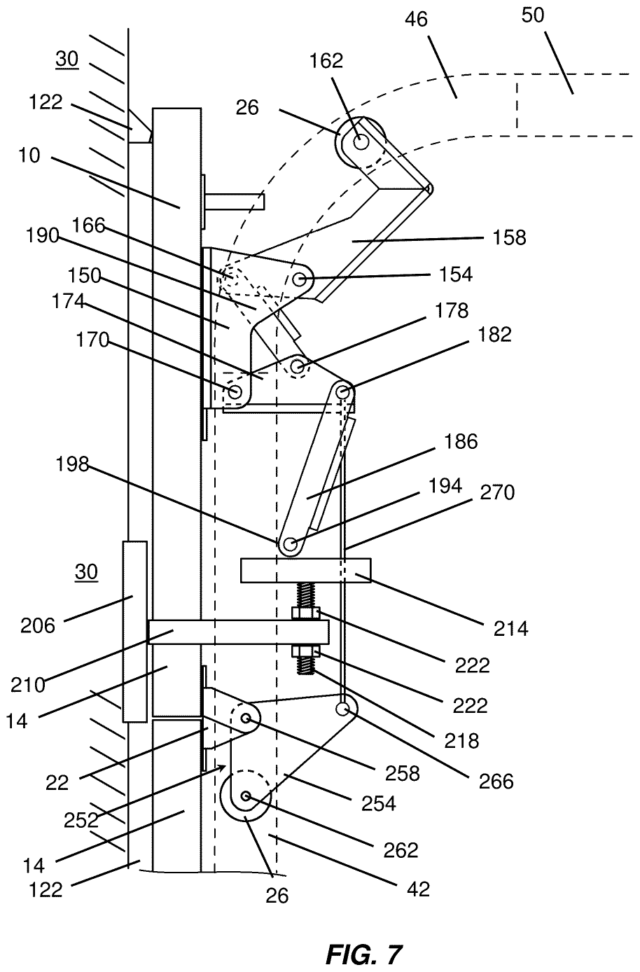

FIG. 7 shows a drawing of the high throw cam system 146 used in combination with a low throw cam assembly 252. As discussed, the high throw cam system 146 provides a high degree of movement of the upper roller wheel 26 away from the upper panel 14 of the garage door 10. In many applications, only the upper roller wheel 26 needs this degree of movement to move the garage door horizontally against a door seal 122 while closing the garage door 10. The low throw cam assembly includes a cam 254 that is pivotably attached to the garage door 10. The example cam 254 is attached to a door panel hinge 22 at a pivot location 258. The example cam 254 includes a lower axle mount 262 that holds a door roller wheel 26 by the roller wheel axle. The roller wheel axle extends laterally from the cam 254 and the wheel 26 is carried in the garage door track 42. The cam 254 also includes an upper actuation point 266. With the door 10 in a vertical, closed position, the lower axle mount 262 is disposed generally beneath the pivot location 258 and the upper actuation point 266 is disposed generally horizontally from the pivot location 258 in a direction away from the wall 30, forming a triangle between the pivot point 258, lower garage door wheel mount 262, and upper actuation point 266. The upper actuation point 266 may be connected to the high throw cam assembly 146 with a linking assembly 270 that functions under tension to pull upwardly on the upper actuation point 266 and rotate the cam 254 about the pivot point 258 and thereby move the associated garage door wheel horizontally relative to the garage door. The garage door wheel 26 moves away from the door 10 and, since the garage door wheel 26 is carried by the garage door track 42, the door 10 is moved away from the track 42 towards the wall 30 and engages the door seal 122. The linking assembly 270 may be a linkage that is compressible and may be shortened under compressive forces but does not elongate past its original length under tension.

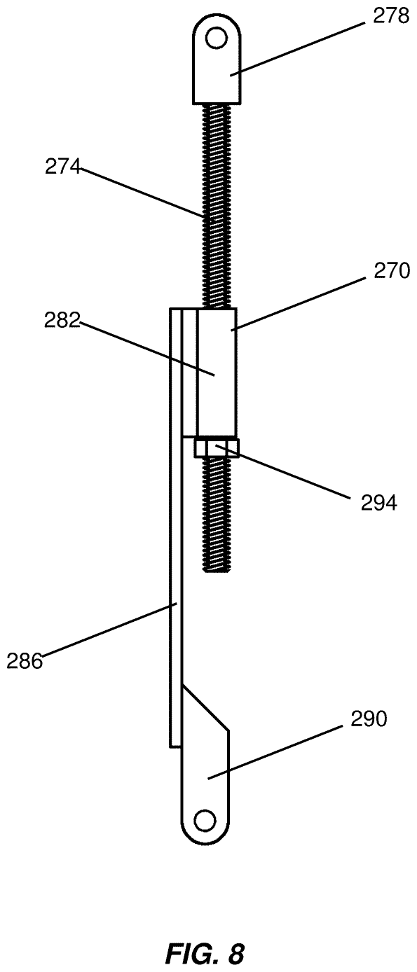

An example linking assembly 270 is shown in FIG. 8. The linking assembly comprises a threaded rod 274 with an upper mounting eye 278 on one end. The threaded rod 274 passes through a non-threaded cylindrical sleeve or tube 282 that is fastened to a body member 286 and a lower mounting eye 290. A lock nut 294 is threaded partially onto the threaded rod 274. The nut 290 controls the maximum length of the linking assembly 270 and allows the low throw cam assembly to be adjusted to control the distance by which the lower portion of the door 10 is moves towards the wall 30 and door seal 122. The threaded rod 274 may slide through the tube 282 to allow the linking assembly 270 to become shorter when necessary, such as when the associated portion of the garage door moves around the curve section of garage door track 46. In an example installation, multiple identical low throw cam assemblies 252 are placed at each side hinge joint 22 along the height of the garage door 10 and at the bottom of the garage door 10 and these are all linked vertically with linking assemblies 270. A single stop bracket 206 may be used to operate the high throw cam assembly 146 and the low throw cam assemblies 252 along the side of the garage door 10. The opposite side of the garage door 10 includes the mirror image cam assemblies, stop bracket, and linking assemblies.

The high throw cam assembly 146 converts linear motion along the garage door track to pivotal motion of the door closing arm 158 and moves the door roller wheel 26 associated with the door closing arm 158 a large distance away from the garage door 10. The high throw cam assembly 146 typically moves the door roller wheel 26 between about 4 inches and about 8 inches away from the garage door 10, but can be made to move the roller wheel 26 a desired distance away from the garage door 10. This large movement of the roller wheel 26 away from the door 10 allows the door 10 to be moved towards the wall 30 and against a door seal even when the roller wheel 26 is positioned along a curved section of track such as the door track 46 with the garage door 10 in a closed position. Garage door installations with low overhead clearance will often have a curved section of garage door track that is near the top of the garage door 10 and that extends below the top of the garage door.

The intermediate lever 174 receives a large movement from an input linkage 186 and reduces this motion so that intermediate linkage 190 moves a smaller distance than the input linkage. The smaller movement of the intermediate linkage results in a smaller pivot distance in the input side of the door closing arm 158 and allows the mounting bracket 150 and door pivot arm 158 to have a lower profile. The large movement distance of the input linkage 186 reduces the input force required to move the door closing arm 158. The large movement distance of the input linkage 186 also allows the position of the door closing arm 158 in the “door closed” position to be more accurately adjusted with less sensitivity to the position of the stop bracket 206.

The garage door closure system discussed herein allows a garage door to close precisely and reliably and improves the ability to seal between the garage door and the wall surrounding the garage door opening. The separation between the garage door and the wall can be easily adjusted to a desired distance that suits the door seal being used. This allows the amount of deflection or compression of the door seal to be precisely adjusted. The system keeps the garage door from rubbing along the garage door seal as it closes, preserving the finish of the garage door and preventing damage to the seal.

The above description of illustrated examples of the present invention, including what is described in the Abstract, is not intended to be exhaustive or to be limiting to the precise forms disclosed. While specific examples of the invention are described herein for illustrative purposes, various equivalent modifications are possible without departing from the broader scope of the present claims. Indeed, it is appreciated that specific example dimensions, materials, etc., are provided for explanation purposes and that other values may also be employed in other examples in accordance with the teachings of the present invention.

What is claimed is:

1. A garage door motion system for closing a garage door comprising:
a garage door track that facilitates movement of the garage door between an open position and a closed position;
a garage door comprising garage door panels, hinges between the garage door panels, and roller wheels carried by the garage door track that move the garage door along the garage door track;
a high throw cam assembly comprising:
a bracket which is attached adjacent a side edge of an upper garage door panel, the bracket comprising a first pivot location and a second pivot location;
a door closing arm which is pivotably attached to the bracket at the first bracket pivot location, the door closing arm comprising a distal end with an axle that holds a garage door roller wheel that engages the garage door track, and a proximal end comprising a second door closing arm pivot location;
an intermediate lever having a first pivot location pivotably attached to the bracket at the second bracket pivot location, the intermediate lever further comprising a second pivot location and a third pivot location;
an input linkage having a first end pivotably attached to the intermediate lever third pivot location and a second end comprising a laterally extending axle and a roller carried on the axle, the roller contacting and moving along an edge of the garage door track;
an intermediate linkage having a first end pivotably attached to the intermediate lever second pivot location and a second end pivotably attached to the door closing arm second pivot location; and
a stationary stop bracket;
wherein, as the garage door is moved towards a closed position, the roller contacts the stop bracket and the stop bracket stops downward movement of the roller and causes the input linkage to pivot the intermediate lever upwards, thereby moving the intermediate linkage upwards and pivoting the door closing arm away from the top garage door panel to separate the door closing arm roller wheel from the top garage door panel and to move the top garage door panel away from the garage door track.

2. The garage door motion system of claim 1, wherein the stop bracket is attached to one of a wall adjacent to the garage door track and the garage door track.

3. The garage door motion system of claim 1, wherein the door closing arm comprises a recess located between the first pivot location and the garage door roller wheel axle, and wherein the garage door comprises a laterally extending door stiffening strut attached to the upper garage door panel, wherein the door stiffening strut is positioned between the bracket and the door closing arm roller wheel when the door closing arm is positioned adjacent the upper garage door panel.

4. The garage door motion system of claim 1, wherein a distance between the door closing arm second pivot location and the first pivot location is between about one third and about one fifth of a distance between the first pivot location and the roller wheel axle location.

5. The garage door motion system of claim 1, wherein a distance between the intermediate lever first pivot location and the intermediate lever second pivot location is about two thirds the distance between the first pivot location and the intermediate lever third pivot location so that the intermediate lever reduces the motion between the input linkage and the intermediate linkage.

6. The garage door motion system of claim 1, further comprising a spring attached to the input linkage, wherein the spring biases the roller against the garage door track.

7. A garage door motion system for closing a garage door comprising:
a garage door track that facilitates movement of the garage door between an open position and a closed position;
a garage door comprising garage door panels, hinges between the garage door panels, and roller wheels carried by the garage door track that move the garage door along the garage door track;
a high throw cam assembly comprising:
a bracket which is attached adjacent a side edge of a garage door panel, the bracket comprising a first pivot location and a second pivot location;
a door closing arm which is pivotably attached to the bracket at the first bracket pivot location, the door closing arm comprising a distal end with an axle that holds a garage door roller wheel that engages the garage door track;
an intermediate lever pivotably attached to the bracket at the second bracket pivot location;
an input linkage having a first end pivotably attached to the intermediate lever and a second end comprising an input arm, wherein the input arm is positioned adjacent an inside edge of the garage door track;
an intermediate linkage having a first end pivotably attached to the intermediate lever and a second end pivotably attached to the door closing arm; and
a stationary stop bracket;
wherein, as the garage door is moved towards a closed position, the input arm contacts the stop bracket and the stop bracket stops further downward movement of the input arm and causes the input linkage to pivot the intermediate lever upwards, thereby moving the intermediate linkage upwards and pivoting the door closing arm away from the garage door panel to separate the door closing arm roller wheel from the garage door panel and to move the garage door panel away from the garage door track.

8. The garage door motion system of claim 7, wherein the intermediate lever is attached to the bracket at a first end of the intermediate lever, wherein the input linkage is attached to a second end of the intermediate lever, and wherein the intermediate linkage is attached to the intermediate lever at a position generally intermediate the first end and second end.

9. The garage door motion system of claim 7, wherein the stop bracket comprises a stop pad which is attached to a stop bracket mounting base, and wherein a distance between the stop pad and the stop bracket mounting base may be adjusted to thereby adjust the actuation of the high throw cam assembly.

10. The garage door motion system of claim 7, wherein the input linkage is pivotably attached to the intermediate lever at a first distance from the second bracket pivot location, wherein the intermediate linkage is pivotably attached to the intermediate lever at a second distance from the second bracket pivot location, and wherein the second distance is less than the first distance such that the intermediate lever reduces motion between the input linkage and the intermediate linkage.

11. The garage motion system of claim 10, wherein the intermediate linkage is attached to the door closing arm at a third distance from the first bracket pivot location, wherein the garage door roller wheel is attached to the door closing arm at a fourth distance from the first bracket pivot location, and wherein the third distance is less than the fourth distance such that the door closing arm increases motion between the intermediate linkage and the garage door roller wheel.

12. The garage door motion system of claim 11, wherein the third distance is between about one third and about one fifth of the fourth distance.

13. The garage door motion system of claim 10, wherein the second distance is about two thirds of the first distance.

14. The garage door motion system of claim 7, further comprising a spring attached to the input linkage, wherein the spring biases the input arm against the garage door track.

15. A garage door motion system for closing a garage door comprising:
a garage door track that facilitates movement of the garage door between an open position and a closed position;
a garage door comprising garage door panels, hinges between the garage door panels, and roller wheels carried by the garage door track that move the garage door along the garage door track;
a high throw cam assembly comprising:
a bracket which is attached adjacent a side edge of a garage door panel;
a door closing arm which is pivotably attached to the bracket at a first bracket pivot location, the door closing arm comprising a distal end with an axle that holds a garage door roller wheel that engages the garage door track;
an input linkage which is connected to the door closing arm and which is independently pivotable relative to the door closing arm, the input linkage comprising an input arm which is positioned adjacent an inside edge of the garage door track such that the input arm moves along the inside edge of the garage door track as the garage door closes;
a stationary stop bracket;
wherein, as the garage door is moved towards a closed position, the input arm contacts the stop bracket and the stop bracket stops further downward movement of the input arm and causes the door closing arm to pivot away from the garage door panel to separate the door closing arm roller wheel from the garage door panel and to move the garage door panel away from the garage door track and towards the wall.

16. The garage door motion system of claim 15, further comprising an intermediate lever pivotably attached to the bracket at a second bracket pivot location, and an intermediate linkage having a first end pivotably attached to the intermediate lever and a second end pivotably attached to the door closing arm, and wherein the input linkage has a first end pivotably attached to the intermediate linkage and wherein the input arm is attached to a second end of the input linkage.

17. The garage door motion system of claim 16, wherein the input linkage is pivotably attached to the intermediate lever at a first distance from the second bracket pivot location, wherein the intermediate linkage is pivotably attached to the intermediate lever at a second distance from the second bracket pivot location, and wherein the second distance is less than the first distance such that the intermediate lever reduces motion between the input linkage and the intermediate linkage.

18. The garage motion system of claim 17, wherein the intermediate linkage is attached to the door closing arm at a third distance from the first bracket pivot location, wherein the garage door roller wheel is attached to the door closing arm at a fourth distance from the first bracket pivot location, and wherein the third distance is less than the fourth distance such that the door closing arm increases motion between the intermediate linkage and the garage door roller wheel.

19. The garage door motion system of claim 18, wherein the third distance is between about one third and about one fifth of the fourth distance.

20. The garage door motion system of claim 15, further comprising a spring attached to the input linkage, wherein the spring biases the input arm against the garage door track.
